(19) United States
(12) Patent Application Publication
(10) Pub. No.: US 2005/0179911 A1
(43) Pub. Date: Aug. 18, 2005

(54) Aspheric diffractive reference for interferometric lens metrology

(75) Inventors: Mark D. Boomgarden, Huntersville, NC (US); William Hudson Welch, Charlotte, NC (US); Christopher J. Linnen, Charlotte, NC (US)

Correspondence Address: Digital Optics Corporation;Attn: Michael R. Feldman, Ph.D, 9815 David Taylor Drive, Charlotte, NC, 28262, US

(73) Assignee: Digital Optics Corporation

(21) Appl. No.: 10/778,335

(22) Filed: Feb. 17, 2004

(51) Int. Cl. G01B 9/02

(52) U.S. Cl. 356/512

(57) ABSTRACT

A diffractive optical element is used to provide an aspherical wavefront to a lens under test in an interferometer or to provide an aspheric null surface. When providing an aspherical wavefront, the diffractive may be in the path of one or both beams to be interfered. Robust and adaptable aspheric testing may be realized.

### BACKGROUND

The accuracy to which a refractive optical element can be manufactured is fundamentally determined by how precisely the shape of the surface of the optical element can be measured. Physical measurement of a surface, such as using a profilometer, is very time consuming. Interferometry is used to measure the departure of a manufactured optical surface from an ideal optical surface. While interferometry allows straightforward testing of simple surfaces, such as flat surfaces and spherical surfaces, creating an ideal reference of more complicated surfaces with which to compare the manufactured surface is difficult. Further, the number of complicated reference surfaces required to measure a wide range of complicated surfaces is impractical.

Accurate interferometric metrology of aspheric surfaces continues to be complicated by several factors. These include decentration, tilt and aperture error between the optical probe wavefront and the surface under test. All of these factors create interactions between the ideally orthogonal Zemike polynomials. Use of a spherical wavefront to test an aspheric surface is another complicating factor in interferometric aspheric metrology. Even for a theoretical surface where the boundary and center are well defined and there are no coma, astigmatism or tilt aberrations, the radius of curvature (R_{c}) of the asphere cannot be accurately resolved. This is due to the fact that the merit function for the curve fitting algorithm will diverge as the spherical wavefront R_{c} approaches the base R_{c} of the asphere. The best fit R_{c} is considerably offset from the true R_{c}.

If an aspheric wavefront is used in the optical probe, the reduced uncertainty would improve the Rc measurement as well as reduce the sensitivity to decentration and aperture matching. Diffractive elements or computer generated holograms (CGH) have been used in conjunction with reference surfaces to extend the usefulness of interferometry for aspheres. However, these techniques still involve validation of many complicated reference surfaces.

### SUMMARY OF THE INVENTION

The present invention is therefore directed to a method and system of interferometrically measuring optical surfaces using a diffractive reference that substantially overcomes one or more of the problems due to the limitations and disadvantages of the related art.

It is a feature of the present invention to provide a diffractive reference at different locations throughout an interferometer used to measure an optical surface. It is another feature of the present invention to shape the wavefront to match an ideal surface of the lens under test. It is yet another feature of the present invention to provide a diffractive reference without altering the interferometer.

At least one of the above and other features may be realized by providing an interferometer including a light source outputting a beam, a detector, a stage for mounting a surface under test, a beam splitter creating a probe beam and a reference beam from the beam, the probe beam and the reference beam to interfere at the detector, and a diffractive optic providing a wavefront of an ideal surface of the surface under test.

At least one of the above and other features may be realized by providing a method for measuring an optical surface including: providing an interferometric system having a probe arm and a reference arm, and including a stage for mounting a surface under test; arranging a diffractive optic providing a wavefront of an ideal surface of the surface under test in the interferometric system, detecting an interference pattern including the wavefront, and using this interference pattern to measure the optical surface.

The diffractive optic may be placed between the light source and the beam splitter or in the path of just the reference beam. When the diffractive optic is placed on the stage, the interferogram of the diffractive optic serves as a calibration null for use with a surface under test. The diffractive optic may include a reflective surface.

These and other features of the present invention will become more readily apparent from the detailed description given hereinafter. However, it should be understood that the detailed description and specific examples, while indicating the preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The foregoing and other features, aspects and advantages will be described with reference to the drawings, in which:

FIG. 1 is a schematic side view of a Twyman-Green interferometer using a diffractive optical element in accordance with a first embodiment of the present invention;

FIG. 2 is a schematic side view of a Twyman-Green interferometer using a diffractive optical element in accordance with a second embodiment of the present invention; and

FIG. 3 is a schematic side view of a Twyman-Green interferometer using a diffractive optical element in accordance with a third embodiment of the present invention.

### DETAILED DESCRIPTION

The present invention will be described in detail through embodiments with reference to accompanying drawings. However, the present invention is not limited to the following embodiments but may be implemented in various types. The embodiments are only provided to make the disclosure of the invention complete and make one having an ordinary skill in the art know the scope of the invention. Throughout the drawings, the same reference numerals denote the same elements.

A diffractive optic may be used to generate an accurate aspheric reference. Since validation of the diffracted wavefront can be accomplished by measurement of flat steps, i.e., the surface is discontinuous in z, the integrity of the diffracted wavefront can be established by a more conventional testing of the mechanical surface structure. Further, the diffractive optic may be used with a variety of aspheres. The diffractive optic may be placed in numerous locations in the interferometer, as illustrated below.

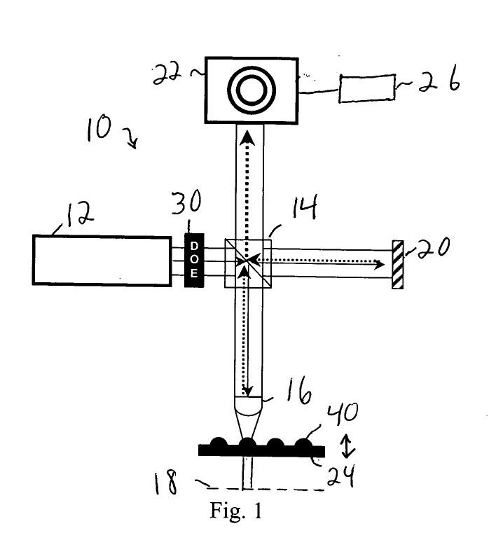

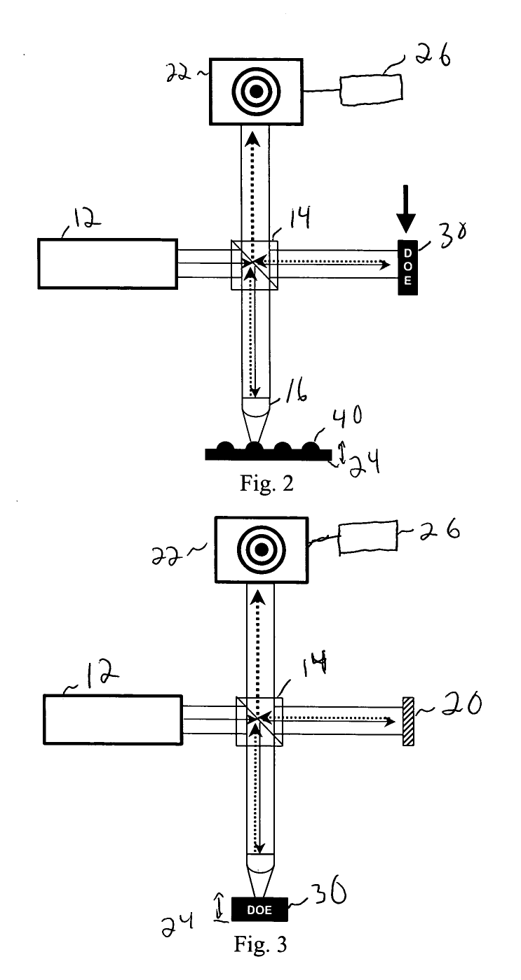

In the examples given below, the basic configuration of an interferometer 10, here shown as a Twyman-Green interferometer remains the same. The interferometer 10, shown in FIGS. 1-3, includes a light source 12, a beam splitter 14, a lens 16, a first mirror 18, a second mirror 20, and a detector 22. A translation stage 24 is provided for mounting a lens under test 40. If the lens under test 40 is reflective, the first mirror 18 is not needed, as shown in FIGS. 2-3. The output of the detector 22 may be fed to a processor 26 having a screen for viewing the interference fringes. The light source may be a laser, e.g., a He—Ne laser, and the detector may be a charge-coupled device (CCD).

Light from the light source 12 is directed onto the beam splitter 14, which splits the light into two beams. Typically, the two beams will have roughly the same intensity to provide maximum fringe contrast in the resulting interference pattern. A first beam proceeds to the lens 16, which focuses the beam onto the lens under test 40 and forms a probe beam. If the lens under test 40 is transparent, the first mirror 18 reflects the probe beam back through the lens under test 40 and the lens 16. Otherwise, the lens under test 40 reflects the probe beam back through the lens 16. The translation stage 24 controls the angular and positional adjustment of the surface under test in known manners. The probe beam is then directed back to the beam splitter 14, which directs the probe beam onto the detector 22. The second beam from the beam splitter 14 is directed to a second mirror 20, forming a reference beam. This reference beam is then directed back through the beam splitter 14 onto the detector 22, where it interferes with the probe beam. The detected interference pattern is output to the computer 26 for analysis and display.

As shown in FIGS. 1-3, the interferometer 10 also includes a diffractive optic 30. This diffractive optic 30 is placed in different locations of the interferometer 10 for the different embodiments. Depending upon the placement of the diffractive optic 30 in the interferometer 10, the diffractive optic 30 may include a thin film coating of a reflective or anti-reflective material. The design for the diffractive will be the same regardless of the position in the interferometer, only the numerical aperture of the objective is changed.

As can be seen in FIG. 1, in this embodiment the diffractive optic 30 is placed in the transmission path to shape the incident beam. This configuration directly shapes the wavefront of the optical probe to match the ideal surface of the lens under test. Both the probe and the reference wavefronts to be interfered have a common profile, thereby minimizing uncertainty in the interferogram. However, the hardware implementation for this embodiment requires changeout and optical alignment of diffractive optic with the optical train of the interferometer for each design that must be tested.

As can be seen in FIG. 2, in this embodiment the diffractive optic 30 also functions as the second mirror 20 for the reference beam. The reference beam thus generates an aspheric reference wavefront to be interfered with the probe wavefront from the lens under test. This configuration reduces the requirements on the optical alignment required when changing designs, since the reference mirror 20 is one of the later optical functions in the train. However, only reference wavefront would have desired profile. This may complicate the analysis of the interference between this beam and a spherical wavefront reflected from the surface under test, which may have aberrations and defocus. This configuration also has a large sensitivity to decenter between the reference beam and the diffractive optic. Since a spherical wavefront is still used as optical probe, large deviations between the spherical wavefront and the aspherical surface under test could cause data dropout at the edge of the lens aperture. Finally, hardware correction would require changeout and optical alignment for each design to be tested.

As shown in FIG. 3, in the third embodiment, the diffractive 30 is placed on the translation stage 24 for the lens under test, and used as a reference null. Reference nulls are conventionally used to correct for errors in the optical train. The resulting phase map of this surface is stored as a data file and then subtracted off of the phase map created during test. This approach would replace the spherical reference surface with an aspheric diffractive null surface. The phase map for the diffracted wavefront would then be subtracted (in software) from the phase map generated during test. Since the use of a reference null involves a software correction, no optical alignment required when changing designs. Further, the interfered beams are not optically modified, so probe and reference wavefronts will have a common profile, and retrace errors will not be exaggerated. Finally, the use of the diffractive 30 in the position of the lens under test would mean that no modification to the interferometer would be required. However, a spherical wavefront is still used as the optical probe. Large deviations between the spherical wavefront and the aspherical surface under test could cause data dropout at the edge of the lens aperture.

Although preferred embodiments of the present invention have been described in detail herein above, it should be clearly understood that many variations and/or modifications of the basic inventive concepts taught herein, which may appear to those skilled in the art, will still fall within the spirit and scope of the present invention as defined in the appended claims and their equivalents.

1. An interferometer comprising:
a light source outputting a beam;
a detector;
a stage for mounting a surface under test;
a beam splitter creating a probe beam and a reference beam from the beam, the probe beam and the reference beam to interfere at the detector;
a diffractive optic providing a wavefront of an ideal surface of the surface under test.

2. The interferometer of claim 1, wherein the diffractive optic is placed between the light source and the beam splitter.

3. The interferometer of claim 1, wherein the diffractive optic is placed in the path of just the reference beam.

4. The interferometer of claim 3, wherein the diffractive optic includes a reflective surface.

5. The interferometer of claim 1, wherein the diffractive optic is placed on the stage and the interferogram of the diffractive optic serves as a calibration null for use with a surface under test.

6. A method for measuring an optical surface comprising:
providing an interferometric system having a probe arm and a reference arm, and including a stage for mounting a surface under test;
arranging a diffractive optic providing a wavefront of an ideal surface of the surface under test in the interferometric system;
detecting an interference pattern including the wavefront; and
using this interference pattern to measure the optical surface.

7. The method of claim 6, wherein said arranging includes positioning the diffractive optic so that the wavefront is provide to both the probe arm and the reference arm.

8. The method of claim 6, wherein said arranging includes positioning the diffractive optic only the probe arm.

9. The method of claim 6, wherein said positioning the diffractive optic only the probe arm includes using the diffractive optic as a reflective surface in the probe arm.

10. The method of claim 6, wherein said arranging includes positioning the diffractive optic on the stage and said using the interference pattern includes subtracting the interference pattern from a pattern produced when the surface under test is mounted on the stage.
